(19) United States
(12) Patent Application Publication
(10) Pub. No.: US 2012/0160429 A1
(43) Pub. Date: Jun. 28, 2012

(54) COUPLING DEVICE FOR A SUNSHADE ASSEMBLY

(75) Inventor: Paul Lin, Tainan City (TW)

(73) Assignee: MACAUTO INDUSTRIAL CO., LTD., Tainan City (TW)

(21) Appl. No.: 13/297,932

(22) Filed: Nov. 16, 2011

(30) Foreign Application Priority Data
Dec. 24, 2010 (TW) 099225042

(51) Int. Cl. E06B 9/80

(52) U.S. Cl. 160/291

(57) ABSTRACT

A coupling device for a sunshade assembly includes a slide block, an insert block and a plug component. The slide block has spaced-apart first and second block bodies connected to a guide member of the sunshade assembly. The first block body has an engaging portion formed on a hole-defining surface that defines a first through hole. The insert block is connected to a cross bar of the sunshade assembly, extends between the first and second block bodies, and is formed with a plug hole registered with the first through hole. The plug component is inserted through the plug hole from the first through hole, and is formed with a first engaging part engaging the engaging portion of the first block body, and a second engaging part spaced apart from the first engaging part and moving over the engaging portion of the first block body during the insertion of the plug member.

### CROSS-REFERENCE TO RELATED APPLICATION

This application claims priority of Taiwanese Application No. 099225042, filed on Dec. 24, 2010.

### BACKGROUND OF THE INVENTION

1. Field of the Invention

The invention relates to a coupling device that is adapted for use in a sunshade assembly for a rear window of an automobile.

2. Description of the Related Art

As shown in FIG. 1, a conventional sunshade assembly 1 for a rear window of an automobile includes a horizontal winding shaft 11 disposed rotatably under a rear window shelf (not shown) of the automobile, a pair of elongated guide rails 12 embedded respectively in two C-columns (not shown) of the automobile and extending from the rear window shelf to a top end of a rear window (not shown) of the automobile, a cross bar 13 disposed above and parallel to the winding shaft 11 and movable between the rear window shelf and the top end of the rear window, a pair of guide members 14 disposed slidably and respectively in the guide rails 12 and connected respectively to opposite ends of the cross bar 13, a driving unit 15 for driving the movement of the guide members 14, and a fabric shade 16 having top and bottom ends that are connected respectively to the cross bar 13 and the winding shaft 11 and extending through a passage opening (not shown) of the rear window shelf. The cross bar 13 includes an elongated main body 131, and a pair of end bar segments 132 inserted telescopically and respectively into opposite ends of the main body 131 so as to permit variation of the length of the cross bar 13. Each of the end bar segments 132 has a free end opposite to the main body 131 and connected co-movably to a respective one of the guide members 14.

When the guide members 14 are driven by the driving unit 15 to move upwardly and respectively along the guide rails 12, the cross bar 13 is also moved upwardly together with the guide members 14, thereby stretching the fabric shade 16. Since the guide rails 12 are arranged in a manner that a horizontal distance between top ends thereof is shorter than that between bottom ends thereof, the end bar segments 132 are urged to gradually slide into the main body 131 during the upward movement of the cross bar 13. On the contrary, the end bar segments 132 would be driven to extend outwardly of the main body 131 to lengthen the cross bar 13 when the cross bar 13 moves downwardly toward the rear window shelf during the folding process of the fabric shade 16.

As such, during the manufacturing process of the conventional sunshade assembly 1, the end bar segments 132 must be assembled precisely with the main body 131 of the cross bar 13 and the guide members 14 to ensure smooth sliding movement of the end bar segments 132 relative to the main body 131 which would lead to smooth movement of the guide members 14 in the guide rails 12.

### SUMMARY OF THE INVENTION

Therefore, the object of the present invention is to provide a coupling device adapted for precisely, quickly and conveniently coupling a cross bar and a guide member of an automobile sunshade assembly.

Accordingly, a coupling device of the present invention is for a sunshade assembly. The sunshade assembly includes a cross bar that extends in a left-right direction, a fabric shade that has a top end coupled to the cross bar, a pair of guide rails that are located respectively at left and right sides of the fabric shade, and a pair of guide members that are disposed slidably and respectively in the guide rails. The coupling device comprises a slide block, an insert block and a plug component. The slide block has a first block body and a second block body. The first block body is adapted to be connected to one of the guide members, and has a hole-defining surface that defines a first through hole extending through the first block body, and an engaging portion that is formed on the hole-defining surface. The second block body is adapted to be connected to the one of the guide members, is spaced apart from and registered with the first block body, and is formed with a second through hole. The insert block is adapted to be connected to an adjacent end of the cross bar, extends between the first and second block bodies of the slide block, and is formed with a plug hole that has opposite hole ends registered respectively with the first and second through holes. The plug component is inserted from the first through hole into the second through hole via the plug hole, and is formed with a first engaging part that engages the engaging portion of the first block body for coupling the slide block to the insert block, and a second engaging part that is spaced apart from the first engaging part and that moves over the engaging portion of the first block body during the insertion of the plug member.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic partly sectional view of a conventional sunshade assembly;

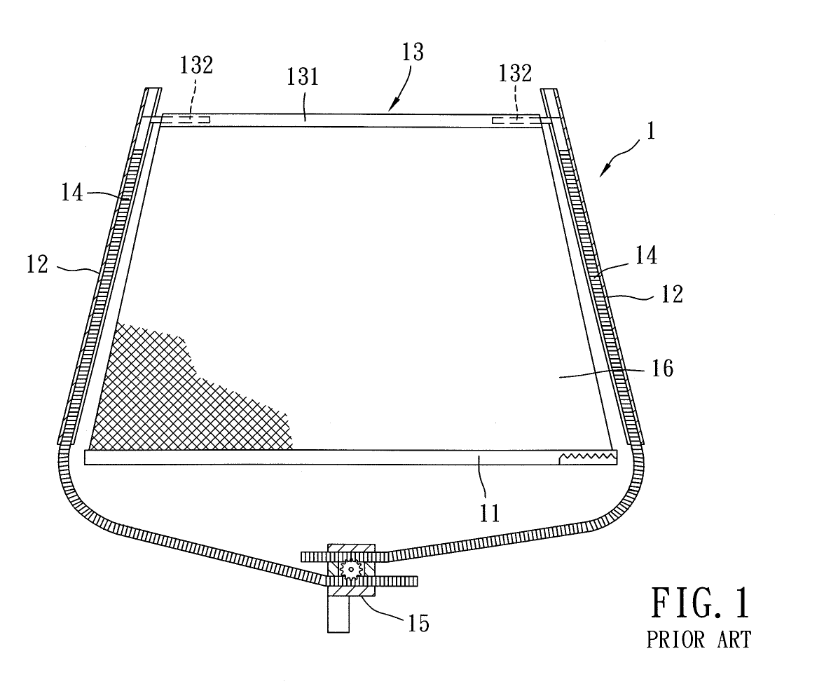

FIG. 2 is a fragmentary schematic partly sectional view of a sunshade assembly mounted with a first preferred embodiment of a coupling device according to the invention;

FIG. 3 is an exploded fragmentary sectional view of the first preferred embodiment;

FIG. 4 is an assembled fragmentary sectional view of the first preferred embodiment; and

FIG. 5 is a perspective view of a plug component of a second preferred embodiment of the coupling device according to the invention.

### DETAILED DESCRIPTION OF THE PREFERRED EMBODIMENTS

Before the present invention is described in greater detail, it should be noted that like elements are denoted by the same reference numerals throughout the disclosure.

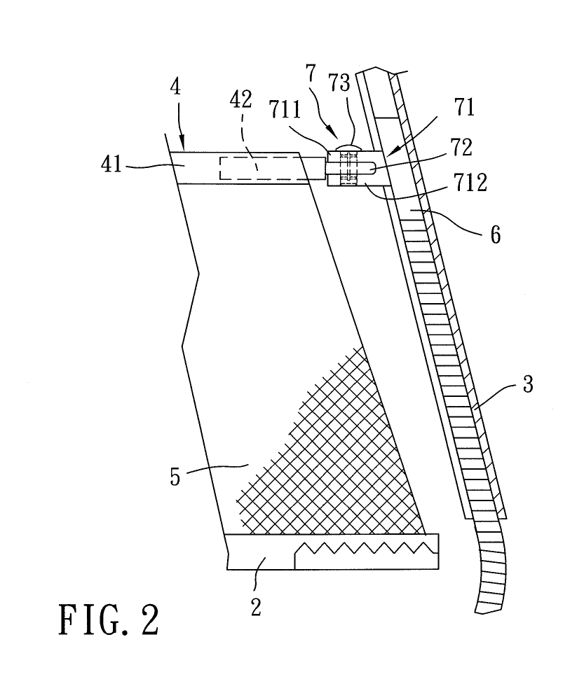

As shown in FIGS. 2 to 4, the first preferred embodiment of a coupling device 7 according to the present invention is adapted for use in a sunshade assembly of an automobile (not shown). The sunshade assembly includes a winding shaft 2 that extends in a left-right direction and that is disposed under a rear window shelf (not shown) of the automobile, a cross bar 4 that is disposed above and parallel to the winding shaft 2 and that is movable between the rear window shelf and a top end of a rear window of the automobile (not shown), a fabric shade 5 that has top and bottom ends coupled respectively to the crossbar 4 and the winding shaft 2, a pair of guide rails 3 (only one is shown) that are located respectively at left and right sides of the fabric shade 5, that are disposed respectively in two C-columns of the automobile (not shown) and that extend from the rear window shelf to the top end of the rear window, and a pair of guide members 6 (only one is shown) that are disposed slidably and respectively in the guide rails 3. The cross bar 4 includes a main body 41 and a pair of end bar segments 42 (only one is shown) inserted telescopically and respectively into opposite ends of the main body 41. The coupling device 7 is adapted for coupling a distal end of one of the end bar segments 42 to a top portion of a respective one of the guide members 6, i.e., two coupling devices 7 of the invention are required for coupling the cross bar 4 to the guide members 6 of the automobile. Since the sunshade assembly has a symmetrical structure, only the right half of the sunshade assembly, including only one of the coupling devices 7, will be described in the following paragraphs for the sake of brevity.

The coupling device 7 includes a slide block 71, an insert block 72 and a plug component 73.

The slide block 71 has a first block 711 that is adapted to be connected integrally to a top portion of the guide member 6, and a second block body 712 that is adapted to be connected integrally to the top portion of the guide member 6 and that is spaced apart from, disposed under and registered with the first block body 711. The first and second block bodies 711, 712 extend outwardly of the guide rail 3. The first block body 711 has a hole-defining surface 713 that defines a first through hole 714 extending through the first block body 711, and an engaging portion 715 formed on the hole-defining surface 713. In this embodiment, the engaging portion 715 is configured as a pair of diametrically-opposite hemispherical protrusions. The second block body 712 is formed with a second through hole 716 registered with the first through hole 714.

The insert block 72 is adapted to be connected to the end bar segment 42 of the cross bar 4 and is extendable between the first and second block bodies 711, 712. The insert block 72 is formed with a plug hole 721 that has opposite hole ends to be registered respectively with the first and second through holes 714, 716.

The plug component 73 is insertable from the first through hole 714 of the slide block 71 into the second through hole 716 of the slide block 71 via the plug hole 721 of the insert block 72. In this embodiment, the plug component 72 has a head segment 731 abutting against a top surface of the first block body 711 of the slide block 71, and a cylindrical stem segment 732 extending from the head segment 731 into the second through hole 716 via the first through hole 714 and the plug hole 721. The stem segment 732 has a surrounding side surface 737 formed with first and second engaging parts 733, 734 that are spaced apart from each other and that are respectively proximate to and distal from the head segment 731, and a slot 735 extending diametrically therethrough. In this embodiment, each of the first and second engaging parts 733, 734 is configured as an annular groove and is engageable with the engaging portion 715 of the slide block 71.

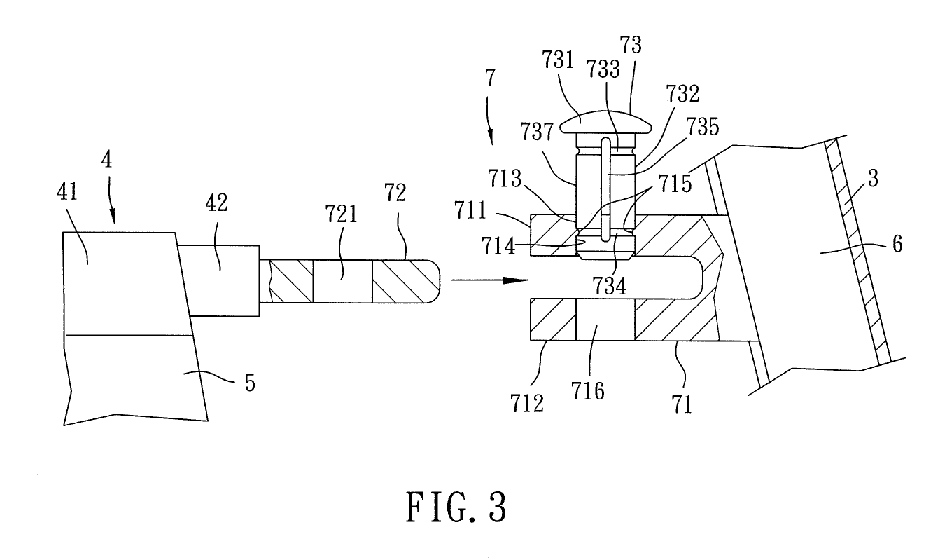

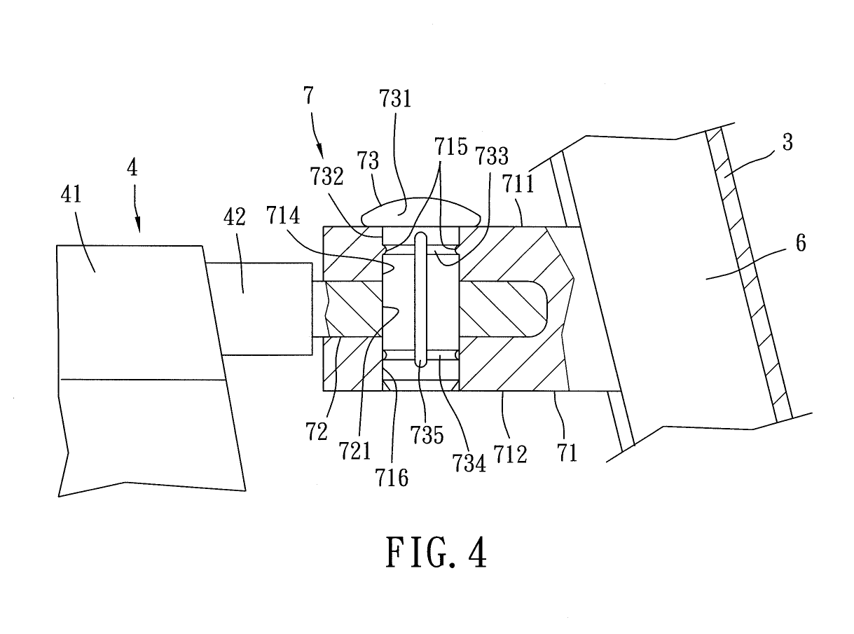

Before assembling the end bar segment 42 of the cross bar 4 to the guide member 6, the plug component 73 is inserted in advance into the first through hole 714 at a position where the second engaging part 734 engages the engaging portion 715 of the slide block 71 for temporarily holding the plug component 73 onto the first block body 711 of the slide block 71 (see FIG. 3). The next procedure of the assembling process would be done in the automobile. When the guide member 6 is mounted together with the guide rail 3 in the C-column of the automobile, the insert block 72 is inserted between the first and second block bodies 711, 712, and the plug component 73 is pushed toward the second block body 712 and extends into the second through hole 716 via the plug hole 721 until the head segment 731 of the plug component 73 abuts against the top surface of the first block body 711 (see FIG. 4). During such movement of the plug component 73, the first engaging part 733 of the plug component 73 is disengaged from and moves over the engaging portion 715 of the slide block 71, and the second engaging part 734 eventually engages the engaging portion 715 at the time the head segment 731 abuts against the first block body 711 to thereby securely couple the cross bar 4 to the guide member 6.

Therefore, due to the pre-installation of the plug component 73 on the slide block 71, the rest of the assembling procedure of the cross bar 4 to the guide member 6 for a personnel in an assembly line of the automobile would be relatively simple and time-saving. Moreover, in this embodiment, the stem segment 732 of the plug component 73 is configured to have a diameter slightly larger than those of the first and second through holes 714, 716 in order to result in a firm engagement between the first engaging part 733 of the plug component 73 and the engaging portion 715 of the slide block 71 when the head segment 731 abuts against the first block body 711. The presence of the slot 735 in the stem segment 732 permits the stem segment 732 to slightly contract during the insertion of the plug component 73 from the first through hole 714 into the second through hole 716, thereby leading to a smooth movement of the plug component 73 relative to the slide block 71.

It should be noted that the configurations of the engaging portion 715 of the slide block 71 and the first and second engaging parts 733, 734 of the plug component 73 may be interchanged in other embodiments of the invention. For example, the engaging portion 715 may be an annular groove formed on the hole-defining surface 713 of the first block body 711 of the slide block 71, while each of the first and second engaging parts 733, 734 may be configured as protrusions.

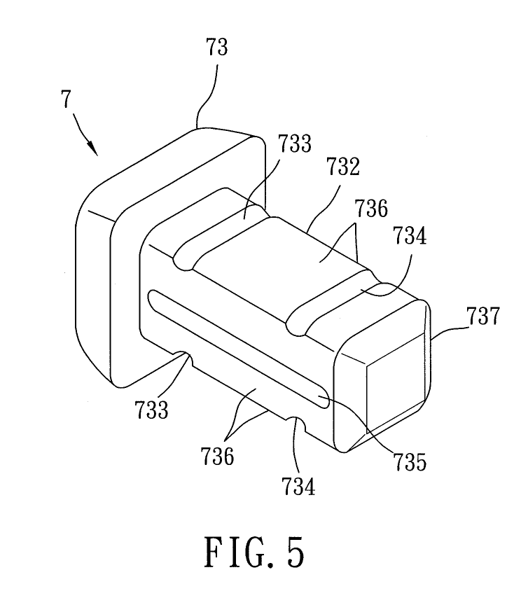

As shown in FIG. 5, the second preferred embodiment of the coupling device 7 according to the present invention has a structure similar to that of the first embodiment. The main difference between this embodiment and the previous embodiment resides in the configuration of the plug component 73. In this embodiment, the stem segment 732 of the plug component 73 is formed as a cuboid, and the surrounding side surface 737 of the stem segment 732 consequently has four surface sections 736. The first engaging part 733 are configured as two grooves formed respectively on two of the surface sections 736 that are opposite to each other, and the second engaging part 734 are configured as two grooves formed respectively on the two of the surface sections 736 and under the first engaging part 733. The slot 735 extends through the other two of the surface sections 736 flanking the first and second engaging parts 733, 734. The second preferred embodiment has the same advantages as those of the first preferred embodiment.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A coupling device for a sunshade assembly, the sunshade assembly including a cross bar that extends in a left-right direction, a fabric shade that has a top end coupled to the cross bar, a pair of guide rails that are located respectively at left and right sides of the fabric shade, and a pair of guide members that are disposed slidably and respectively in the guide rails, said coupling device comprising:
a slide block having
a first block body that is adapted to be connected to one of the guide members, said first block body having a hole-defining surface that defines a first through hole extending through said first block body, and an engaging portion that is formed on said hole-defining surface, and
a second block body that is adapted to be connected to the one of the guide members and that is spaced apart from and registered with said first block body, said second block body being formed with a second through hole;
an insert block adapted to be connected to an adjacent end of the cross bar, extending between said first and second block bodies of said slide block, and formed with a plug hole that has opposite hole ends registered respectively with said first and second through holes; and
a plug component inserted from said first through hole into said second through hole via said plug hole, and being formed with a first engaging part that engages said engaging portion of said first block body for coupling said slide block to said insert block, and a second engaging part that is spaced apart from said first engaging part and that moves over said engaging portion of said first block body during insertion of said plug member.

2. The coupling device as claimed in claim 1, wherein said plug component has:
a head segment abutting against said first block body of said slide block; and
a stem segment extending from said head segment into said second through hole via said first through hole and said plug hole, and having a surrounding side surface formed with said first and second engaging parts.

3. The coupling device as claimed in claim 2, wherein said stem segment of said plug component is cylindrical, said first and second engaging parts being annular and surrounding said surrounding side surface of said stem segment.

4. The coupling device as claimed in claim 3, wherein said stem segment of said plug component further has a slot extending diametrically therethrough.

5. The coupling device as claimed in claim 2, wherein said stem segment of said plug component is formed as a cuboid, said surrounding side surface of said stem segment having four surface sections, said first and second engaging parts being formed on one of said surface sections.

6. The coupling device as claimed in claim 5, wherein said stem segment of said plug component further has a slot that extends through two of said surface sections flanking said first and second engaging parts.
